(19) United States
(12) Patent Application Publication
(10) Pub. No.: US 2004/0114839 A1
(43) Pub. Date: Jun. 17, 2004

(54) Hydrostatic gas bearing

(76) Inventors: Toshio Mukai, Chiyoda-ku (JP); Keigo Ishitobi, Kitakyushu-shi (JP)

Correspondence Address: BAKER & BOTTS, 30 ROCKEFELLER PLAZA, NEW YORK, NY, 10112

(21) Appl. No.: 10/692,766

(22) Filed: Oct. 24, 2003

(30) Foreign Application Priority Data
Oct. 24, 2002 (JP) 2002-309354 (PAT.

(51) Int. Cl. F16C 32/06

(52) U.S. Cl. 384/12

(57) ABSTRACT

A hydrostatic gas bearing having particular damping characteristics is provided. The hydrostatic gas bearing is of the orifice type having an air groove communicated with a gas injection port, wherein when a bearing clearance is denoted by h and a depth of the air groove by g, h is not larger than 5 μm and g/h is not smaller than 5. The material of the guide, slider and orifice constituting the bearing is alumina, silicon carbide, silicon nitride, Sialon, cordierite, or a composite ceramic including any one of them, as a main component.

### CROSS-REFERENCE TO RELATED APPLICATION(S)

The present application claims priority under 35 U.S.C. § 119 from Japanese Patent Application No. 2002-309354 filed on Oct. 24, 2002, the entire disclosure of which is incorporated herein by reference.

### FIELD OF THE INVENTION

Precision machine tools and inspection apparatus generally use a moving stage for bringing work or a mother disk into a position at high speed while maintaining high precision. The present invention is relates to a hydrostatic gas bearing used for the moving stage.

### BACKGROUND INFORMATION

A hydrostatic gas bearing is constituted between a guide and a slider of a moving stage. Usually, a gas such as the air is injected to the guide from an orifice provided in the slider to form a gaseous film having bearing stiffness between the guide and the slider. Upon forming the gaseous film, the static pressure gas bearing works as a non-contact bearing having stiffness.

The gas bearing is a clean bearing which is contactless and does not require a lubricant such as oil or the like, but has poor vibration damping performance, due to the effect of compressibility of gas, and a small coefficient of viscosity. For example, the amplitude of free vibration in the viscous damping system becomes small being proportional to exp (−ξωₙt) (where ξ is the damping ratio and ωₙ is the specific angular vibration number of the system), and ξ of the air bearing is in many cases about 0.05. To improve stopping performance or synchronizing performance of the stage, it is advantageous to use a bearing having a large damping ratio ξ. There is no known prior art which describes a radical improvement of the damping ratio ξ.

The orifice-type bearing has an air groove, communicated with the orifice, formed in the whole surface of the bearing to enhance its stiffness. The clearance of the bearing of this type is preferably not smaller than 5 μm, and the depth of the air groove is preferably not larger than 20 μm (for example, see Japanese Patent Publication No. 3-213718, the entire disclosure of which is incorporated herein by reference). The clearance of the bearing is preferably set to be not smaller than 5 μm generally because the member constituting the bearing is a metal, and it is likely difficult to machine the bearing surface. Besides, even if precisely finished, the bearing is scarred during the use and precision is not, in many cases, maintained. Further, iron-based materials or aluminum-based materials used for the bearing has a large coefficient of thermal expansion, and the clearance of the bearing varies depending upon a change in the ambient temperature and it is considered that the bearing characteristics vary to a large extent. The depth of the air groove is likely limited to be not larger than 20 μm because, when the depth is greater than this value, the bearing becomes unstable and often undergoes self-excited vibration.

### SUMMARY OF THE INVENTION

It is one of the objects of the present invention to provide a hydrostatic gas bearing having particular damping characteristics.

Theoretical calculations have been conducted according to the present invention, while greatly varying the clearance of the bearing and the depth of the groove, without being hampered by a traditional technology of bearings, under circumstances where a ceramic, such as alumina and the like, can now be used as bearing materials on an industrial basis. A bearing according to an exemplary embodiment of the present invention provides a high damping ratio, while having a small bearing clearance. Additional details of the present invention are provided as follows.

According one exemplary embodiment of the present invention, a hydrostatic gas bearing (of the orifice type having an air groove communicated with a gas injection port) is provided. When a bearing clearance is denoted by h and a depth of the air groove by g, h is likely not larger than 5 μm and g/h is likely not smaller than 5. The material of parts constituting the bearing can include alumina, silicon carbide, silicon nitride, Sialon, cordierite, or a composite ceramic comprising any one of them, as a main component.

An end of the orifice on the side of injecting the gas can be defined to be the gas injection port.

### BRIEF DESCRIPTION OF THE DRAWINGS

FIG. 1 is a schematic illustration of a bearing of an orifice type according to an exemplary embodiment of the present invention;

FIG. 2 is a schematic illustration of a structure of an air groove of a cross-T shape;

FIG. 3 is a diagram illustrating the calculated results of a damping ratio ξ of when the bearing clearance is h=3 μm;

FIG. 4 is a diagram illustrating the calculated results of a damping ratio ξ of when the bearing clearance is h=5 μm; and

FIG. 5 is a diagram illustrating the calculated results of a damping ratio ξ of when the bearing clearance is h=7 μm.

### DETAILED DESCRIPTION

Exemplary embodiments of the present invention are described below. Though the described embodiments are based on simulated results based on hydrodynamics, those having ordinary skill in the art would clearly understand and know that the results are closely reproduced even in an experiment.

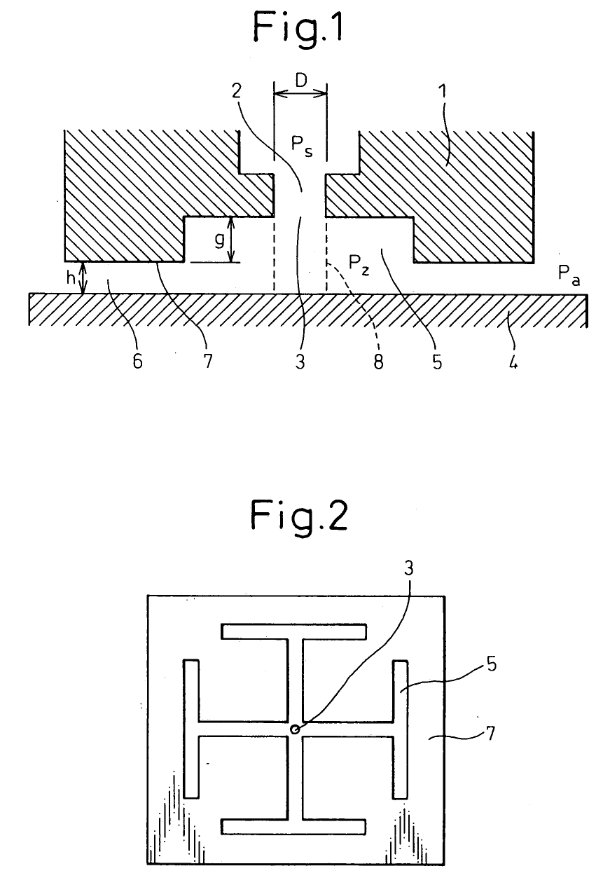

A bearing 1 according to the exemplary embodiment of the present invention is a hydrostatic gas bearing that uses an orifice 2 as gas injection means. FIG. 1 shows a sectional view of the hydrostatic gas bearing which uses the orifice 2 as gas injection means. Prior to providing details regarding the relationship between the squeezing effect and the mass flow rate of the gas according to the present invention, FIG. 1 illustrates an example where a inherently-compensated state is realized in an air groove 5 immediately below the orifice 2.

A gas that is fed at a feed pressure Pₛ is injected from the gas injection port 3 at an end of the orifice 2, and assumes a pressure P_{z} when it spreads in the air groove 5 due to the squeezing effect based on adiabatic expansion (e.g., due to an inherently-compensated restriction effect in the case of the example shown in FIG. 1). The gas from an imaginary cylinder 8 immediately below the orifice 2 spreads in the air groove 5, and is emitted to the exterior of the bearing 1 from the air groove 5 passing through a bearing land 7. The gas pressure decreases down to the atmospheric pressure Pₐ while receiving a viscous resistance as it passes from the air groove 5 to the end of the bearing through the land 7.

According to the hydrodynamics, the mass flow rate of the gas is provided as follows:

(1) Mass flow rate injected from the orifice 2,

M₁=[C_{D}APₛ/(RT)^{1/2}]·Ψ₀

where, when P_{z}/Pₛ≧[2/(κ+1)]^{κ/(κ-1)}

A=πD(g+h)

Ψ₀=[2κ/(κ−1)]^{1/2}·[(P_{z}/Pₛ)^{2/κ}−(P_{z}/Pₛ)^{(κ+1)/κ}]^{1/2}

(2) Mass flow rate that goes out through the bearing clearance 6 while receiving viscous resistance,

M₂=[(h+g)³/24 μRT].[C_{i,j}P²_{i,j}−C_{i,j-1}P²_{i,j-1} . . . ]

which is a matrix expression based on the calculation by a method of finite differences as a prerequisite. Here, P_{i,j} is a pressure at a point (i, j), C_{i,j} is a coefficient thereof, and other parameters are as described below.

D: diameter of orifice, g: depth of air groove, h: clearance of bearing, C_{D}: coefficient of flow rate (=0.9), μ: coefficient of viscosity of the gas, R: gas constant, T: temperature, κ: ratio of specific heat.

In an equilibrium state, a balance is maintained in the mass that enters into, and goes out from, a divisional element inclusive of the orifice. Namely, M₁=M₂. The mass flow rate is preserved even in the air groove and in the land other than the orifice and, hence, there is derived a relationship between pressures at the lattice points for each of the divisional elements. By solving these relationships, a distribution of equilibrium pressure is obtained.

When there is a change with the passage of time, the following relationship applies (M₁=0 for the divisional element without including orifice).

M₁−M₂=(1/RT).∂(P_{i,j}.V_{i,j})/∂t

where V_{i.j} is a volume of the bearing clearance in the divisional element at a point (i, j). The dynamic characteristics can be calculated based on a method of perturbation about an equilibrium point. Namely, a formula was established as h=h₀+Δh·exp (iωt), P_{i,j}=P₀+ΔP_{i,j}·exp(iωt), and relationships for finding a complex dynamic stiffness E_{i,j}=ΔP_{i,j}/Δh were derived for each of the lattice points. These relationships are preferably simultaneously solved to find E_{i,j} for each of the lattice points. When the sum of real number components of E_{i,j} for all lattice point is denoted by A and the sum of imaginary number components by B, the damping ratio ξ is given by ξ=B/(2A). The damping ratio ξ varies depending upon the frequency f (where ω=2πf). In the calculation of the hydrodynamics, the calculated results are rearranged depending upon the squeeze number σ which varies in proportion to the frequency. A squeeze number of a rectangular pad having a longitudinal size a and a transverse size b is expressed by the following formula,

σ=(12 μω/Pₐ)·(a·b/c²)

where c is a representative bearing clearance which may assume any value. In this calculation, however, c=5 μm is employed. In such case, the pad stands for a portion where the gas pressure is greater than the atmospheric pressure limiting the bearing surface.

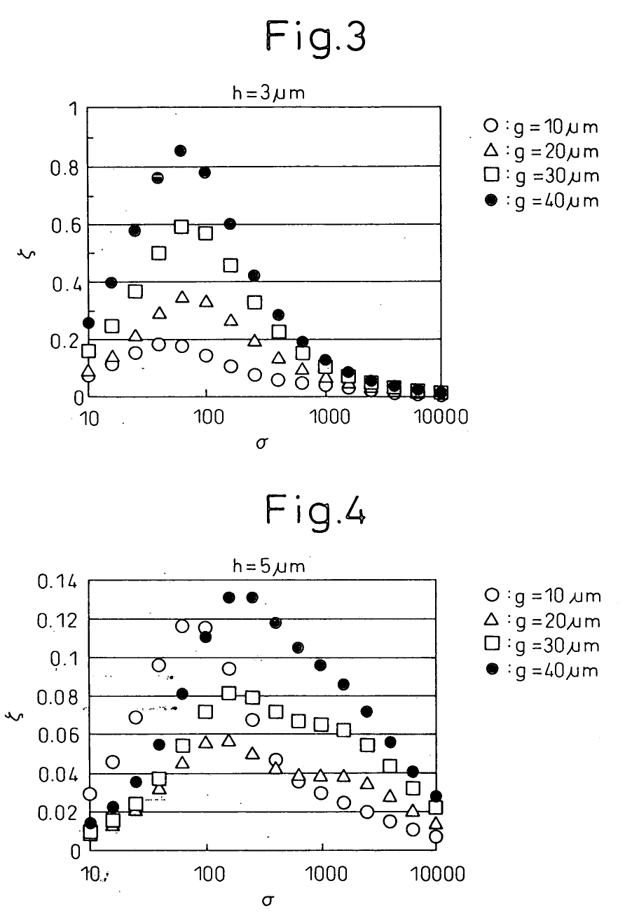

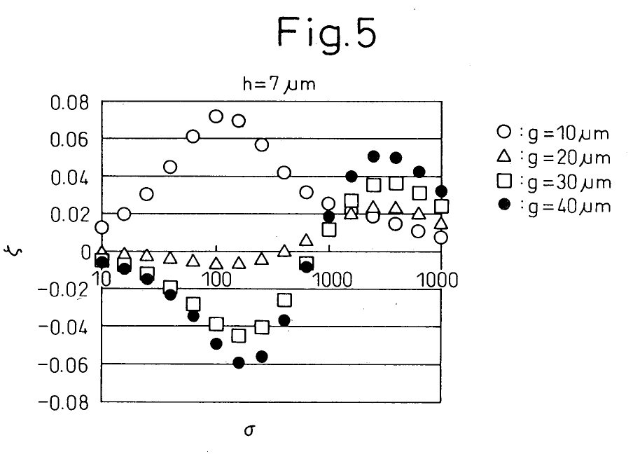

An exemplary embodiment of the present invention is described with reference to the air groove of an exemplary cross-T pattern. FIG. 2 shows an exemplary model bearing used for the calculation. The pad size thereof is a=b=40 mm, the orifice 2 has a diameter D=0.2 mm, and the air groove 5 has a width of 1 mm. The distance (land width) from the center line of the air groove of the outermost circumference to the outer periphery of the pad is 6 mm. The feed pressure is 0.4 MPa in terms of a pressure difference from the atmospheric pressure, and the groove depth g is varied to calculate the damping ratio ξ with respect to the typical bearing clearance h. FIGS. 3, 4 and 5 show the calculated results of when h=3, 5 and 7 μm with respect to the squeeze number σ.

With a bearing clearances of h=5 to 7 m, which can typically be utilized, the damping ratio can significantly change depending upon the depth of the air groove. When the groove depth exceeds 20 μm, there may be a region of a where the damping ratio assumes a negative sign. In the region where the damping ratio assumes a negative sign, the bearing can undergo a self-excited vibration. Therefore, the bearing would likely not be used in this region. These tendencies greatly change when h=3 μm. For example, as the groove depth increases, conversely, the damping ratio increases in the positive direction. The exemplary embodiment of the present invention is generally based on these new findings. In particular, unlike the conventional concept, the phenomenon in which the damping ratio increases with an increase in the depth of the air groove, appears when the bearing clearance is preferably not larger than 5 μm. As a first condition of the exemplary embodiment of the present invention, therefore, the bearing clearance h is set to be preferably not larger than 5 μm. Further, this phenomenon becomes conspicuous as a relative value of the air groove depth g and the bearing clearance h increases. Calculation generally show that the phenomenon becomes conspicuous at around g/h=5. As a second condition of the exemplary embodiment of the present invention, therefore, g/h can be set to be not smaller than 5.

The present invention is not limited to the pad structure of this exemplary embodiment. The diameter of the orifice 2 may be from about 0.1 to about 0.3 mm, and two or more orifices 2 may be included in one pad. Further, the structure of the air groove 5 communicated with the orifice is not limited to the cross-T shape only of this embodiment. The similar result can be obtained even with groove structures which are separately communicated with two or more orifices. In this embodiment, the groove has a single depth. The depth, however, may be varied depending upon the portions of the groove without departing from the spirit and scope of the invention.

As the bearing clearance 6 decreases, it becomes preferably to select the material of the members constituting the bearings. With the customarily used iron-based or aluminum-based metals, it is difficult to carry out the machining maintaining high precision. Besides, the bearing is scarred while being assembled or used and, often, becomes unusable. Further, the above metals have a large coefficient of thermal expansion, and the bearing clearance undergoes a change depending upon a change in the temperature during the use. A narrow clearance may often be extinguished due to a rise in the temperature. When the bearing clearance is limited to be not larger than 5 μm as provided in the exemplary embodiment of the present invention, it is generally not desired to use the above-mentioned metals. Instead, a ceramic can be preferably used that can be easily machined in a high precision without being scarred caused by contact and the like, and that permits the size to change little irrespective of a change in the temperature.

As a ceramic for the bearing of the present invention, there can be preferably used alumina which is inexpensive, has a high rigidity and has a coefficient of thermal expansion which is as low as 5.3 ppm/K. When a more high rigidity is preferred, silicon carbide having a coefficient of thermal expansion of 2.3 ppm/K can be used. As a bearing used maintaining a bearing clearance of not larger than 3 μm, in particular, silicon nitride or Sialon having a coefficient of thermal expansion at room temperature of 1.2 ppm/K or cordierite-based zero-expansion ceramics having a coefficient of thermal expansion of not larger than 0.1 ppm/K can be used.

According to the exemplary embodiment of the present invention, it is preferable that the slider 1, guide 4 and orifice constituting the bearing are all made of the same type of ceramic. However, the member (nozzle) having the orifice 2 may be separately mounted and made of a ceramic of a different kind or a different metallic material. The air groove 5 can be formed by ordinary fine machining using a diamond drill, or by laser machining or a sand blast machining.

According to the exemplary embodiment of the present invention, the bearing clearance can be set to be not larger than 5 μm and the air groove depth g/bearing clearance h may be selected to be not smaller than 5, in order to realize an orifice type hydrostatic gas bearing having a very high damping ratio.

According to another exemplary embodiment of the present invention, the material of parts constituting the bearing can be alumina, silicon carbide, silicon nitride, Sialon, cordierite, or a composite ceramic of any one of them, as a chief component to realize a bearing that can be easily machined in a high precision without being scarred by contact and the like, and that permits the size to change little irrespective of a change in the temperature.

What is claimed is:

1. A hydrostatic gas bearing of an orifice type, comprising:
a gas injection port; and
an air groove communicating with the gas injection port,
wherein a clearance (h) of the bearing is at most 5 μm, and the ratio of a depth (g) of the air groove to the clearance (h) is at least 5.

2. The hydrostatic gas bearing according to claim 1, wherein materials of the gas bearing include, as a main component, at least one of alumina, silicon carbide, silicon nitride, Sialon, cordierite and a composite ceramic.
